(19) United States
(12) Patent Application Publication
(10) Pub. No.: US 2020/0003572 A1
(43) Pub. Date: Jan. 2, 2020

(54) TRAVEL ASSISTANCE DEVICE

(71) Applicant: Mitsubishi Electric Corporation, Tokyo (JP)

(72) Inventors: Hisanobu MASUDA, Tokyo (JP); Mitsuo SHIMOTANI, Tokyo (JP); Yasushi KODAKA, Tokyo (JP); Keisuke INOUE, Tokyo (JP)

(73) Assignee: Mitsubishi Electric Corporation, Tokyo (JP)

(21) Appl. No.: 16/474,800

(22) PCT Filed: Jan. 23, 2017
(86) PCT No.: PCT/JP2017/002152

§ 371 Date: Jun. 28, 2019

(51) Int. Cl. G01C 21/36; G08G 1/0969; G09B 29/10

(52) U.S. Cl. CPC G01C 21/36; G09B 29/10; G08G 1/0969

(57) ABSTRACT

An object of the present invention is to achieve an efficient route search and a creation of detailed guidance information. A travel assistance device according to the present invention includes: an information acquisition unit acquiring road connection information which expresses a connection relationship of roads in units of roads and does not include shape information of roads, first traffic lane reference information which expresses a connection relationship of roads in units of traffic lanes and includes shape information of traffic lanes, and corresponding information which associates the road connection information with first traffic lane reference information; a route search unit searching a travel route of a vehicle using the road connection information; and a guidance information creation unit creating guidance information for guiding the vehicle using the first traffic lane reference information of the travel route.

### TECHNICAL FIELD

The present invention relates to a device, a method, and a data structure for a travel assistance of a vehicle.

### BACKGROUND ART

A travel assistance device searches a travel route of a vehicle, creates guidance information of the travel route, and proposes the guidance information to the vehicle or a driver of the vehicle, thereby performing a travel assistance of the vehicle.

A travel assistance device of Patent Document 1 performs a travel assistance of a vehicle using road reference information, corresponding information, and traffic lane reference information. The road reference information is information expressing a connection relationship of roads in units of roads, and includes shape information of the roads. The traffic lane reference information is information expressing a connection relationship of roads in units of traffic lanes, and includes shape information of the traffic lanes. The corresponding information is information for associating the road reference information with the traffic lane reference information. The travel assistance device of Patent Document 1 performs a route search using the road reference information, and performs a detailed leading guidance for the vehicle using the traffic lane reference information.

### PRIOR ART DOCUMENTS

### Patent Documents

Patent Document 1: Japanese Patent Application Laid-Open No. 2006-266865

### SUMMARY

### Problem to be Solved by the Invention

The travel assistance device of Patent Document 1 performs the route search using the load reference information including the shape information of the road, however, the shape information of the road is unnecessary for the route search, so that there is a problem that a reading of useless data occurs in the route search and a calculation efficiency decreases. In the meanwhile, detailed data including shape data of the road or the traffic lane may be necessary to create the guidance information of the vehicle in some cases.

The present invention therefore has been made to solve these problems, and it is an object of the present invention to achieve both an efficient route search and a creation of detailed guidance information.

### Means to Solve the Problem

A travel assistance device according one aspect of the present invention includes: an information acquisition unit acquiring road connection information which expresses a connection relationship of roads in units of roads and does not include shape information of roads, first traffic lane reference information which expresses a connection relationship of roads in units of traffic lanes and includes shape information of traffic lanes, and corresponding information which associates the road connection information with first traffic lane reference information; a route search unit searching a travel route of a vehicle using the road connection information; a traffic lane reference information acquisition unit acquiring the first traffic lane reference information of a traffic lane necessary to perform a leading guidance of the travel route from the road connection information and the corresponding information of the travel route; and a guidance information creation unit creating guidance information for guiding the vehicle using the first traffic lane reference information of the travel route.

### Effects of the Invention

A travel assistance device according one aspect of the present invention includes: an information acquisition unit acquiring road connection information which expresses a connection relationship of roads in units of roads and does not include shape information of roads, traffic lane reference information which expresses a connection relationship of roads in units of traffic lanes and includes shape information of traffic lanes, and corresponding information which associates the road connection information with traffic lane reference information; a route search unit searching a travel route of a vehicle using the road connection information; a traffic lane reference information acquisition unit acquiring the first traffic lane reference information of a traffic lane necessary to perform a leading guidance of the travel route from the road connection information and the corresponding information of the travel route; and a guidance information creation unit creating guidance information for guiding the vehicle using the first traffic lane reference information of the travel route. According to the travel assistance device described above, an efficient route search can be performed using the road connection information which does not include the shape information of the road, and the detailed guidance information can be created using the first traffic lane reference information including the shape information of the traffic lane.

These and other objects, features, aspects and advantages of the present invention will become more apparent from the following detailed description of the present invention when taken in conjunction with the accompanying drawings.

### BRIEF DESCRIPTION OF DRAWINGS

FIG. 1 A block diagram illustrating a configuration of a travel assistance device according to an embodiment 1,

FIG. 2 A flow chart illustrating travel assistance processing performed by the travel assistance device according to the embodiment 1.

FIG. 3 A block diagram illustrating a configuration of a travel assistance device according to embodiments 2 and 3.

FIG. 4 A drawing illustrating a data structure of road connection information.

FIG. 5 A drawing illustrating a data structure of traffic lane reference information.

FIG. 6 A drawing illustrating a data structure of traffic lane link shape data.

FIG. 7 A drawing illustrating a relationship between the road connection information, the traffic lane reference information, and corresponding information.

FIG. 8 A conceptual diagram illustrating an association between a road node and road link expressed by the road connection information and a traffic lane node and traffic lane link expressed by the traffic lane reference information in accordance with the corresponding information.

FIG. 9 A flow chart illustrating travel assistance processing performed by the travel assistance device according to the embodiment 2.

FIG. 10 A drawing illustrating a display example of guidance information created using traffic lane reference information of all of the traffic lanes.

FIG. 11 A drawing illustrating a display example of guidance information created using traffic lane reference information of a representative traffic lane.

FIG. 12 A flow chart illustrating traffic lane reference information acquisition processing performed by the travel assistance device according to the embodiment 2.

FIG. 13 A drawing illustrating a data structure of traffic lane reference information having representative traffic lane information.

FIG. 14 A drawing illustrating a data structure in a case where corresponding information relating to a road link R2 illustrated in FIG. 8 has representative traffic lane information.

FIG. 15 A drawing highlighting a representative traffic lane by a dotted line in a road expressed by the traffic lane reference information illustrated in FIG. 8.

FIG. 16 A drawing illustrating a data structure of traffic lane connection information.

FIG. 17 A drawing illustrating a data structure of traffic lane reference information.

FIG. 18 A drawing illustrating a relationship between the road connection information, the traffic lane reference information, and corresponding information.

FIG. 19 A drawing illustrating corresponding information in a case where a setting point of a node is different between the traffic lane connection information and the traffic lane reference information.

FIG. 20 A flow chart illustrating travel assistance processing performed by the travel assistance device according to the embodiment 3.

FIG. 21 A flow chart illustrating travel route search processing performed by the travel assistance device according to the embodiment 3.

FIG. 22 A drawing illustrating a data structure of traffic lane connection information having representative traffic lane information.

FIG. 23 A drawing illustrating a road expressed by the traffic lane connection information and a representative traffic lane in the road.

FIG. 24 A drawing illustrating a data structure of corresponding information in which the representative traffic lane information is described.

FIG. 25 A drawing illustrating a road expressed by the traffic lane reference information and a representative traffic lane in the road.

FIG. 26 A block diagram illustrating a configuration of a travel assistance device according to an embodiment 4.

FIG. 27 A drawing illustrating a data structure of second traffic lane reference information.

FIG. 28 A flow chart illustrating travel assistance processing performed by the travel assistance device according to the embodiment 4.

FIG. 29 A hardware configuration diagram of the travel assistance device according to the present invention.

FIG. 30 A hardware configuration diagram of the travel assistance device according to the present invention.

FIG. 31 A diagram illustrating a configuration example of an in-vehicle device and a server of the travel assistance device according to the embodiments 1 to 3.

### DESCRIPTION OF EMBODIMENT(S)

### A. Embodiment 1

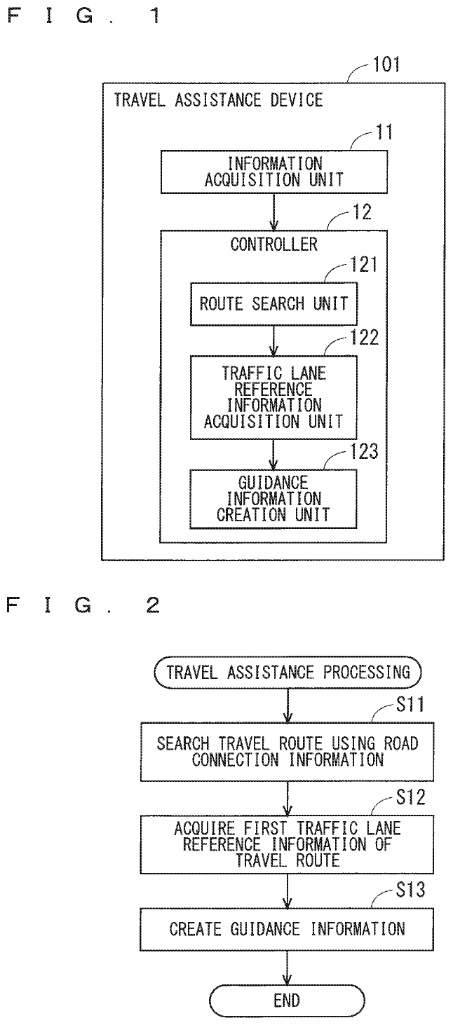

FIG. 1 is a block diagram illustrating a configuration of a travel assistance device 101 according to an embodiment 1 of the present invention. The travel assistance device 101 is a device which creates guidance information of a route along which a vehicle is scheduled to travel hereafter (simply referred to as “travel route” hereinafter), thereby assisting a traveling of the vehicle. In the present specification, the term “vehicle” is used in a sense of a vehicle on which the travel assistance device of the present invention performs a travel assistance. In the present specification, the travel assistance device is described as a device mounted on the vehicle, however, it is described as one example, thus various configurations are assumed as described in <E. Hardware configuration> hereinafter.

The travel assistance device 101 includes an information acquisition unit 11 and a controller 12. The controller 12 includes a route search unit 121, a traffic lane reference information acquisition unit 122, and a guidance information creation unit 123.

The information acquisition unit 11 acquires road connection information, traffic lane reference information, and corresponding information from an external map information server, for example. The road connection information is information which expresses a connection relationship of roads in units of roads and does not include shape information of roads. The traffic lane reference information is information expressing a connection relationship of roads in units of traffic lanes and including shape information of the traffic lanes. The corresponding information is information for associating the road connection information with first traffic lane reference information in the same road section. The traffic lane reference information used in travel assistance devices 101 to 103 in embodiments 1 to 3 is different from traffic lane reference information used by a travel assistance device 104 in an embodiment 4, thus the former is referred to as first traffic lane reference information and the latter is referred to as second traffic lane reference information to distinguish them in the description hereinafter.

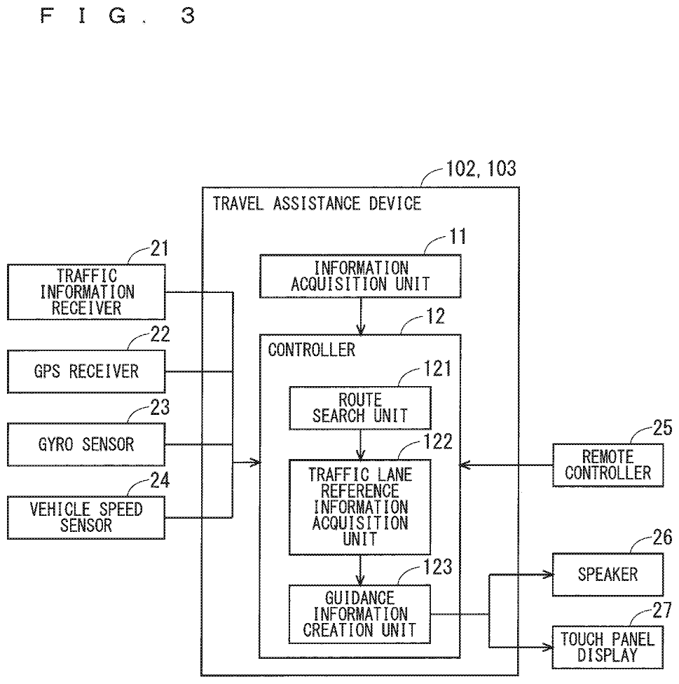

FIG. 2 is a flow chart illustrating travel assistance processing performed by the travel assistance device 101. Firstly, the route search unit 121 searches a travel route of a vehicle using road connection information (Step S11). Next, the traffic lane reference information acquisition unit 122 acquires the first traffic lane reference information of the travel route from the road connection information and corresponding information of the travel route (Step S12). Next, the guidance information creation unit 123 creates the guidance information for guiding the vehicle using the first traffic lane reference information of the travel route (Step S13). The travel assistance processing performed by the travel assistance device 101 is finished through the steps described above.

As described above, according to the travel assistance device 101, the travel route of the vehicle is searched using the road connection information. Since the road connection information is light data which does not include shape information of the road, the travel assistance device 101 needs not read useless data in searching the travel route, thus can perform the route search efficiently. The travel assistance device 101 acquires the first traffic lane reference information of the travel route based on the corresponding information, and creates the guidance information based on the first traffic lane reference information. Since the first traffic lane reference information is the information including the shape information of the traffic lane, the travel assistance device 101 can create the detailed guidance information in units of traffic lanes. The road connection information and the first traffic lane reference information are associated with each other by the corresponding information, thus both the efficient route search and the creation of the detailed guidance information can be achieved.

A travel assistance method according to the embodiment 1 includes: acquiring road connection information which expresses a connection relationship of roads in units of roads and does not include shape information of roads, first traffic lane reference information which expresses a connection relationship of roads in units of traffic lanes and includes shape information of the traffic lanes, and corresponding information which associates the road connection information with first traffic lane reference information; searching a travel route of a vehicle using the road connection information; acquiring the first traffic lane reference information of the traffic lane necessary to perform a leading guidance of the travel route from the road connection information of the travel route and the corresponding information; and creating guidance information for guiding the vehicle using the first traffic lane reference information of the travel route. Accordingly, according to the travel assistance method according to the embodiment 1, the route search can be performed efficiently by the light road connection information which does not include the shape information of the road. The detailed guidance information in units of traffic lanes can be created by the first traffic lane reference information including the shape information of the traffic lane. The road connection information and the first traffic lane reference information are associated with each other by the corresponding information, and the first traffic lane reference information is referenced from the road connection information using the corresponding information, thus both the efficient route search and the creation of the detailed guidance information can be achieved.

The data structure of road map information according to the embodiment 1 includes road connection information which expresses a connection relationship of roads in units of roads and does not include shape information of roads, first traffic lane reference information which expresses a connection relationship of roads in units of traffic lanes and includes shape information of the traffic lanes, and corresponding information which associates the road connection information with first traffic lane reference information. An effect described hereinafter is achieved by using the road map information having such a data structure. That is to say, the route search can be performed efficiently by the light road connection information which does not include the shape information of the road. The detailed guidance information in units of traffic lanes can be created by the first traffic lane reference information including the shape information of the traffic lane. The first traffic lane reference information is referenced from the road connection information using the corresponding information, thus both the efficient route search and the creation of the detailed guidance information can be achieved.

### B. Embodiment 2

<B-1. Configuration>

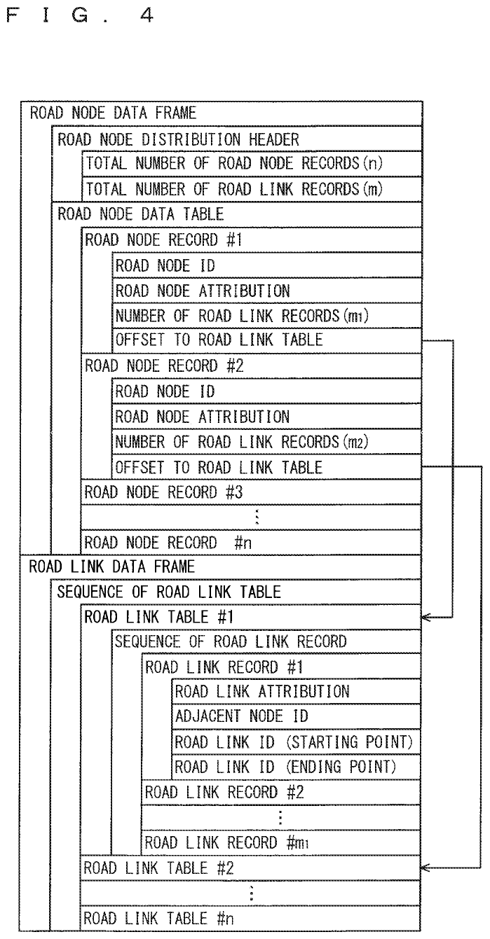

FIG. 3 is a block diagram illustrating a configuration of a travel assistance device 102 according to an embodiment 2 of the present invention. The configuration of the travel assistance device 102 is similar to the configuration of the travel assistance device 101 according to the embodiment 1. However, the travel assistance device 102 is communicably connected to a traffic information receiver 21, a global positioning system (GPS) receiver 22, a gyro sensor 23, a vehicle speed sensor 24, a remote controller 25, a speaker 26, and a touch panel display 27, and can collectively control them.

The traffic information receiver 21 is mounted on the vehicle, for example, receives traffic information and outputs the traffic information to the controller 12. The traffic information can be received from a traffic information transmitter disposed on the road or a traffic information server, for example. The traffic information is vehicle information and communication system (VICS: registered trademark) information, for example, and includes traffic congestion information or construction information.

The GPS receiver 22 is mounted on the vehicle, for example, receives a GPS signal and outputs the GPS signal to the controller 12.

The gyro sensor 23 is mounted on the vehicle, for example, detects an angular speed of the vehicle, and outputs the angular speed to the controller 12.

The vehicle speed sensor 24 is a sensor measuring a speed of the vehicle, and outputs vehicle speed information to the controller 12.

The route search unit 121 performs the route search using the traffic information acquired from the traffic information receiver 21. The route search unit 121 specifies a position of the vehicle using various types of information acquired from the GPS receiver 22, a gyro sensor 23, and the vehicle speed sensor 24, and uses the position of the vehicle for the route search. The gyro sensor 23 and the vehicle speed sensor 24 are described herein as the sensors detecting the information for specifying the position of the vehicle, however, they are described as the example, thus the other sensor may be added in place of or in addition to them.

The remote controller 25 is an input device for a user of the travel assistance device 102, such as a driver of the vehicle, to input data to the travel assistance device 102.

The speaker 26 and the touch panel display 27 are illustrated in FIG. 3 as examples of output devices of the travel assistance device 102. These output devices are mounted on the vehicle, for example, and output the guidance information created by the guidance information creation unit 123 in a form of sound or display. The touch panel display 27 is the output device, however, it also functions as the input device. For example, the touch panel display 27 can be used as the input device in a manner of setting a specific point on a map displayed in the touch panel display 27 to a destination of the vehicle when the user touches the specific point.

<B-2. Data Structure>

Next, various types of data used by the travel assistance device 102 for the travel assistance processing is described. The information used by the travel assistance device 102 for the travel assistance processing includes three pieces of information, that is, the road connection information, the first traffic lane reference information, and the corresponding information. These pieces of information are acquired by the information acquisition unit 11, and are offered to the controller 12.

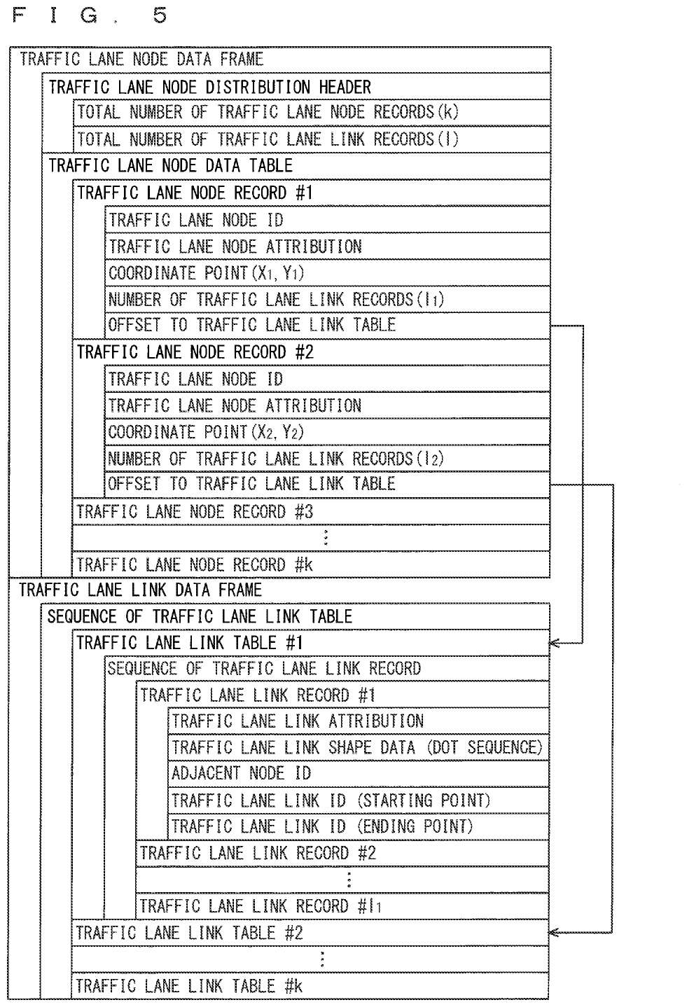

FIG. 4 illustrates a data structure of the road connection information. The road connection information is information expressing the road not in units of traffic lanes but in units of roads by a plurality of road nodes and a plurality of road links. The road connection information is used for travel route search processing performed by the route search unit 121.

In the present specification, a node or a link being set in units of roads is referred to as a road node or a road link, and a node or a link being set in units of traffic lanes is referred to as a traffic lane node or a traffic lane link. The road connection information includes a road node data frame and a road link data frame. The road node data frame includes a road node distribution header and a road node data table. The road node distribution header stores a total number of road node records (n) and a total number of road link records (m). The total number of road node records (n) indicates a total number of road nodes being set in a road section expressed by the road connection information. The total number of road link records (m) indicates a total number of road links connected to the road nodes being set in the road section expressed by the road connection information.

The road node data table is made up of a plurality of road node records. In the example in FIG. 4, the total number of road node records is indicated by n, and there are n road node records. Each road node record stores a road node ID, a road node attribution, a total number of road link records, and an offset to a road link table. Examples of the road node attribution include, for example, “an integrated intersection flag” indicating whether one intersection is expressed by the plurality of nodes, “an intersection traffic light presence-absence flag” indicating presence or absence of a traffic light in the intersection, or information indicating whether or not the road node is the node being set in a branch point in the road. In a road node record #1, the number of the road link records is indicated by ml, and it indicates that ml road links are connected to the road node of the road node record #1. The offset to the road link table indicates an offset value to a memory address which stores the corresponding road link table. For example, the offset to the road link record in the road node record #1 indicates the offset value to the road link table #1 which stores data of the road link connected to the road node of the road node record #1.

The road link data frame includes a plurality of road link tables. Since the pieces of information relating to the road link connected to one road node is collected as one road link table, there are the road link tables, the number of which is the same as that of the road nodes. Each road link table includes a plurality of road link records. For example, when the three road links are connected to the road node of the road node record #1, the road link table #1 has the three road link records.

Each road link record includes a road link attribution, an adjacent node ID, a road link ID (starting point), and a road link ID (ending point). An attribution of the road link is described in the road link attribution. The attribution of the road link includes a road type such as a general road or an express highway, for example, or information of a legal speed of a road. The adjacent node ID indicates an ID of the other road node to which the road link is connected. In the example in FIG. 4, the road link record #1 belongs to the road link table #1 as the road link connected to the road node of the road node record #1, and the ID of the other road node connected in a side opposite to the road node of the road node record #1 is described as the adjacent node ID.

The road link ID (starting point) and the road link ID (ending point) respectively indicate IDs of the road links in a starting point side and an ending point side in the road connection information on a lowermost layer in a case where the road connection information is layered by a roughness of the road node. When a setting interval between the road nodes decreases in a lower layer, a section expressed by one road link in the road connection information in an upper layer is expressed by a plurality of road links in the road connection information in a lower layer. For example, the road section expressed by the road link of the road link record #1 is expressed by the plurality of road links in the lowermost road connection information, thus the ID of the road link in the starting point side and the ID of the road link in the ending point side in the plurality of road links are described in the road link record.

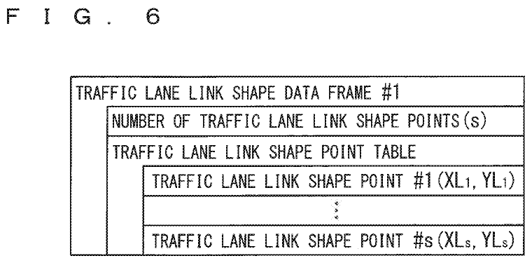

FIG. 5 illustrates a data structure of the first traffic lane reference information. The first traffic lane reference information is information expressing the road in units of traffic lanes by the plurality of traffic lane nodes and the plurality of traffic lane links, and includes the shape data of the traffic lane. The first traffic lane reference information is acquired by the traffic lane reference information acquisition unit 122, and is used by the guidance information creation unit 123 for guidance information creation processing.

As illustrated in FIG. 5, the first traffic lane reference information has a data structure largely similar to the road connection information except that the unit of the node and link changes from the road to the traffic lane. However, the first traffic lane reference information is different from the road connection information in that it has a coordinate point of the traffic lane node in the traffic lane node record and has traffic lane link shape data in the traffic lane link record.

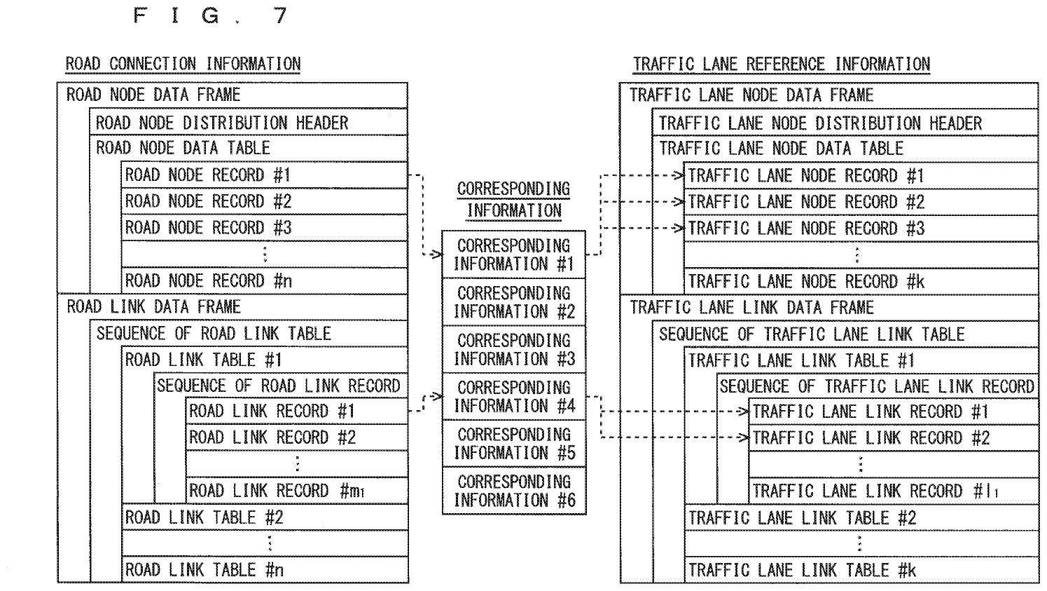

FIG. 6 is a drawing illustrating a data structure of the traffic lane link shape data. The traffic lane link shape data has a total number of traffic lane link shape points (s) constituting the traffic lane link and a traffic lane link shape point table. Coordinates of s traffic lane link shape points are described in the traffic lane link shape point table.

Differing from the first traffic lane reference information, the road connection information does not have the coordinate point of the road node and the road link shape data. Since the link shape data includes the data of the coordinates of the plurality of link shape points as illustrated in FIG. 6, the road link shape data for all of the road links is enormous. However, the road connection information does not have the road link shape data, thus has a small amount of data for the road link shape data. The road connection information may have information of the road node coordinate point. In that case, a data amount of the road connection information increases, however, there is an advantage that a confirmation whether the road node is set in an appropriate position can be easily performed.

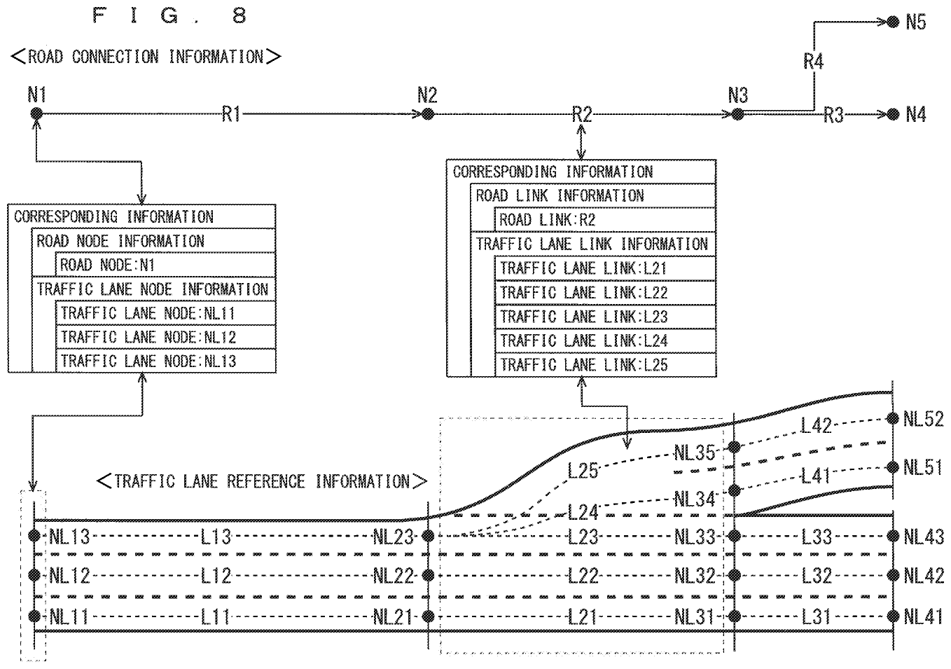

FIG. 7 is a drawing illustrating a relationship between the road connection information, the first traffic lane reference information, and the corresponding information. As illustrated in FIG. 7, corresponding information #1 associates a road node record #2 with traffic lane node records #1 to #3, and corresponding information #2 associates a road link record #1 with a traffic lane link record #1. In this manner, the corresponding information associates one road node record with one or a plurality of traffic lane node records.

FIG. 8 is a conceptual diagram illustrating an association between the road node and road link expressed by the road connection information and the traffic lane node and traffic lane link expressed by the first traffic lane reference information in accordance with the corresponding information. As illustrated in FIG. 8, in the corresponding information, traffic lane nodes NL11, NL12, and NL13 are associated with a road node N1, and traffic lane links L21 to L25 are associated with a road link R2. Herein, one road section is set between the road nodes N1 and N2 and one road section is set between the road nodes N2 and N3. One road section is set between the road nodes N3 and N4 and the road nodes N4 and N5. The corresponding information associates the road node with the traffic lane node or the road link with the traffic lane link in the same road section. It is also applicable that the traffic lane links L21 to L25 belonging to one road section are grouped and collectively associated with the road link R2 as is the case in the corresponding information illustrated in FIG. 8. Alternatively, the corresponding information may associate the road link with the traffic lane link one-on-one.

FIG. 8 illustrates a case where the node is set in the same point by the road connection information and the first traffic lane reference information. An end point of the road link and an end point of the traffic lane link can be associated with each other by the corresponding information. However, for example, when the road connection information and the first traffic lane reference information are established by the other manufacturer, the setting point of the node may be different in the road connection information and the first traffic lane reference information. In that case, the corresponding information cannot associate the end points of the road link and traffic lane link, thus may associate the road link with both the adjacent two traffic lane links or associate the road link with one of the starting point side and the ending point side of the traffic lane link.

<B-3. Operation>

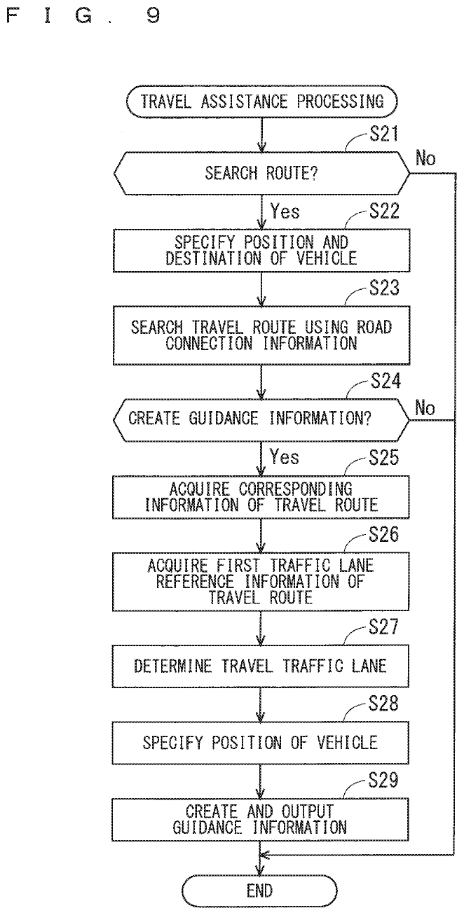

FIG. 9 is a flow chart illustrating travel assistance processing performed by the travel assistance device 102. The travel assistance processing is described hereinafter along the flow in FIG. 9. The travel assistance processing is started at a predetermined timing such as a timing of when a power source of the travel assistance device 102 is activated or a timing of when a power source of an accessory in the vehicle is activated. Firstly, the route search unit 121 determines whether or not the route search is performed (Step S21). For example, the route search unit 121 can perform the determination described above in accordance with an intention of a user being input to a screen by displaying the screen on the touch panel display 27 to confirm the intention of the user whether or not to perform the route search. Alternatively, it is also applicable that the route search unit 121 determines that the route search is not performed when the user does not input the destination and the destination is not set in the controller 12.

When the route search unit 121 determines that the route search is not performed in Step S21, the travel assistance processing is finished. In the meanwhile, when the route search unit 121 determines that the route search is performed in Step S21, the route search unit 121 specifies a position and destination of the vehicle (Step S22). The position of the vehicle is specified based on signals from the GPS receiver 22, the gyro sensor 23, and the vehicle speed sensor 24. When the user has already input a destination, the route search unit 121 may specify the destination, or when the user has not input a destination yet, the route search unit 121 may display a screen to input the destination, thereby making the user input the destination.

Next, the route search unit 121 searches the travel route of the vehicle using the road connection information acquired from the information acquisition unit 11 (Step S23). As described above, the road connection information is the light data which does not include the shape data of the road, thus the travel route can be efficiently searched. In this step, the travel route of the vehicle is specified in units of roads.

Next, the traffic lane reference information acquisition unit 122 determines whether or not to create the guidance information (Step S24). Herein, for example, the traffic lane reference information acquisition unit 122 can perform the determination described above in accordance with an intention of a user being input to a screen by displaying the screen on the touch panel display 27 to confirm the intention of the user whether or not the guidance information needs to be created. Alternatively, the traffic lane reference information acquisition unit 122 may determine not to create the guidance information when a setting not to perform the leading guidance is performed in the travel assistance device 102.

When the traffic lane reference information acquisition unit 122 determines not to create the first traffic lane reference information in Step S24, the travel assistance processing is finished. In the meanwhile, when the traffic lane reference information acquisition unit 122 determines to acquire the first traffic lane reference information in Step S24, the traffic lane reference information acquisition unit 122 acquires the corresponding information of the travel route searched by the route search unit 121 in Step S23 from the information acquisition unit 11 (Step S25).

Next, the traffic lane reference information acquisition unit 122 acquires the first traffic lane reference information of the travel route from the information acquisition unit 11 with reference to the corresponding information (Step S26).

When the steps described above are described by taking a case where the road link R2 is the travel route in FIG. 8 as an example, the traffic lane reference information acquisition unit 122 acquires the corresponding information regarding the road link R2 (Step S25). Then, the traffic lane reference information acquisition unit 122 acquires the traffic lane links L21 to L25 associated with the road link R2 by the corresponding information (Step S26).

Next, the traffic lane reference information acquisition unit 122 specifies one traffic lane in the plurality of traffic lanes, the first traffic lane reference information of which is acquired in Step S26, as a travel traffic lane, that is to say, the travel route in units of traffic lanes (Step S27). Specifically, the traffic lane reference information acquisition unit 122 determines one traffic lane in the plurality of traffic lanes in the target road section as the traffic lane link of the travel traffic lane. In the example in FIG. 8, the road links of the travel route are defined as the road links R1, R2, and R4. The travel route is a route branched to the road link R4 at the road node N3 on the road connection information. Herein, the vehicle needs to travel along the traffic lane link L24 or L25 in the immediately previous section to travel the traffic lane link L41 or L42 corresponding to the road link R4. In the similar manner, the vehicle needs to travel along the traffic lane link L13 in the immediately previous section to travel the traffic lane link L24 or L25. Accordingly, the traffic lane link of the travel route is determined as the traffic lane links L13, L25, and L42 or the traffic lane links L13, L24, and L41. As described above, the traffic lane reference information acquisition unit 122 performs the specification in view of the relationship with the traffic lane node or traffic lane link in a road section one or several sections ahead in specifying the travel traffic lane in a road section.

Next, the guidance information creation unit 123 specifies a position of the vehicle (Step S28). The method of specifying the position of the vehicle in the present step is similar to Step S22. Then, the guidance information creation unit 123 creates the guidance information from the first traffic lane reference information, and outputs the guidance information to the output device such as the speaker 26 or the touch panel display 27 (Step S29).

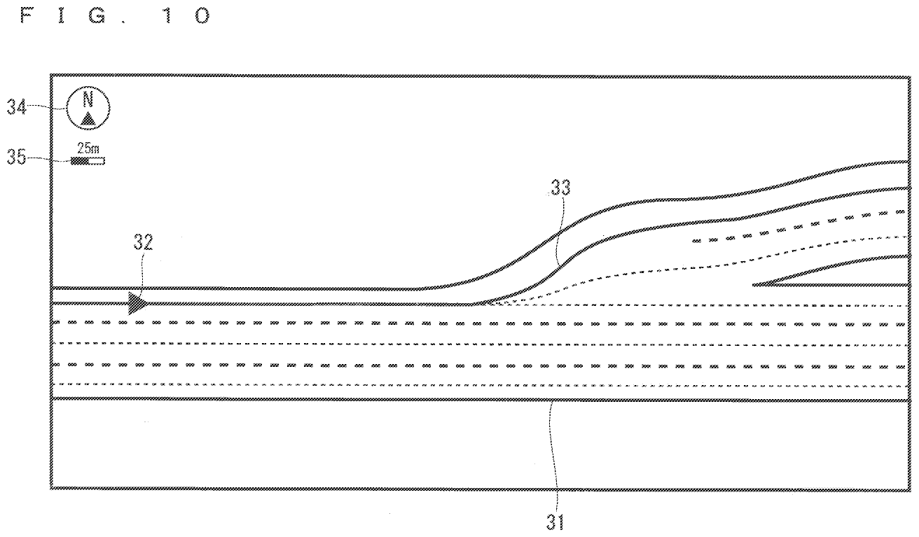

FIG. 10 illustrates an example of a guidance screen displayed on the touch panel display 27 in a case where the traffic lane links L13, L24, and L41 are the travel traffic lane in the example in FIG. 8. As illustrated in FIG. 10, the guidance screen displays a road object 31 expressing the road in units of traffic lanes, a vehicle icon 32 expressing the position of the vehicle, a travel route 33, a direction icon 34, and a map scale 35. Herein, the road object 31 is displayed on not only the traffic lane of the travel route 33 but also all of the other traffic lanes. That is to say, the guidance information creation unit 123 creates the guidance information using not only the travel traffic lane but also the first traffic lane reference information of all of the other traffic lanes. According to the guidance information described above, the user can recognize a positional relationship between the traffic lane of the travel route and the other traffic lanes. Since the first traffic lane reference information includes the shape data of the traffic lane link, the guidance information creation unit 123 can create the road object 31 reflecting the shape of the traffic lane.

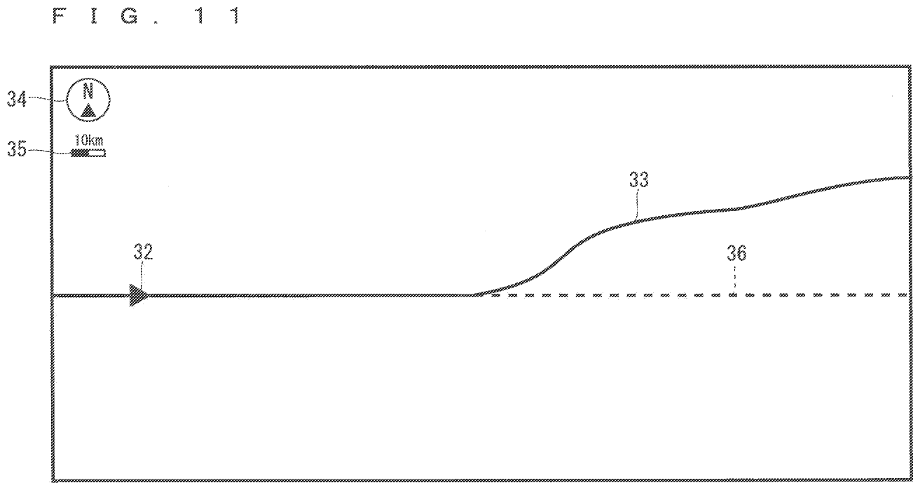

The guidance screen FIG. 10 is created using the first traffic lane reference information of all of the traffic lanes, thus a calculation cost increases in creating the guidance screen. The detailed guidance information can be obtained in the guidance screen in FIG. 10, however, such detailed guidance information is not necessarily required by the user constantly. For example, as illustrated in FIG. 11, when the map scale of the guidance screen is large, it is also considered that a display of a rough travel route suffices as the guidance screen. FIG. 11 illustrates the guidance screen in which a representative traffic lane is set in each of a main lane and a branch lane in a branched road and only the first traffic lane reference information of the representative traffic lane is used. The representative traffic lane of the branch lane coincides with the travel route. The guidance screen in FIG. 11 displays the direction icon 34, the map scale 35, the vehicle icon 32, the travel route 33, and a representative traffic lane 36 other than the travel route. The calculation cost can be reduced as necessary by using the guidance screen in FIG. 10 and the guidance screen in FIG. 11 differently.

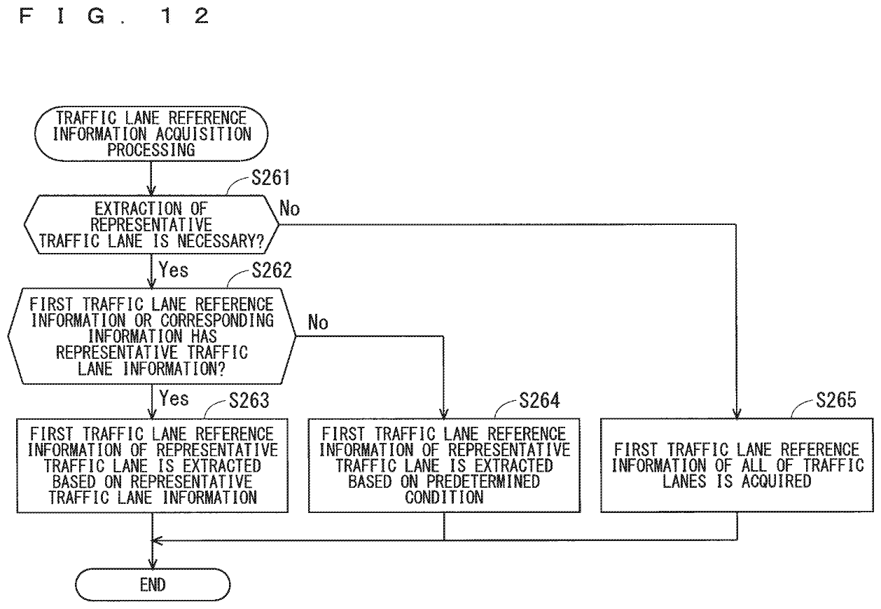

FIG. 12 is a flow chart illustrating details of the traffic lane reference information acquisition processing in Step S26 in FIG. 9. Firstly, the traffic lane reference information acquisition unit 122 determines whether or not an extraction of the representative traffic lane is necessary (Step S261). Herein, the traffic lane reference information acquisition unit 122 determines whether or not the extraction of the representative traffic lane is necessary based on a size of a scale of the created guidance screen, for example. When the extraction of the representative traffic lane is unnecessary, the traffic lane reference information acquisition unit 122 acquires the first traffic lane reference information of all of the traffic lanes in the corresponding road section (Step S265), and finishes the traffic lane reference information acquisition processing. That is to say, the guidance information is created using the first traffic lane reference information of all of the traffic lanes in the corresponding road section.

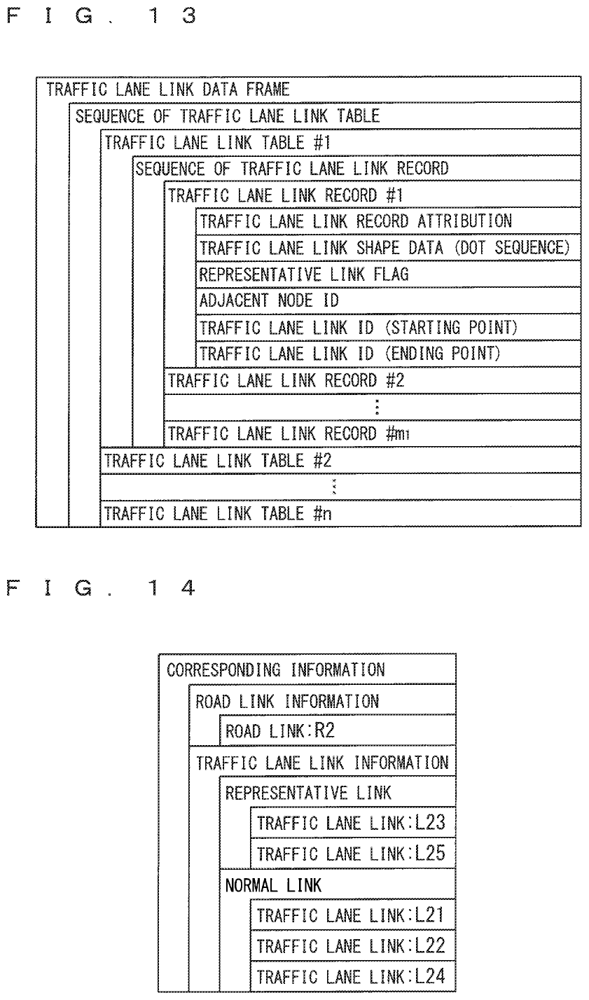

In the meanwhile, when the extraction of the representative traffic lanes is necessary, the traffic lane reference information acquisition unit 122 determines whether or not the first traffic lane reference information or the corresponding information has representative traffic lane information (Step S262). FIG. 13 illustrates a data structure of the first traffic lane reference information having the representative traffic lane information. As illustrated in FIG. 13, a traffic lane link record has a representative link flag. In the traffic lane link record of the representative traffic lane, the representative link flag indicates 1, and in the traffic lane link record of the traffic lane other than the representative traffic lane, the representative link flag indicates 0. As described above, the representative link flag is the representative traffic lane information.

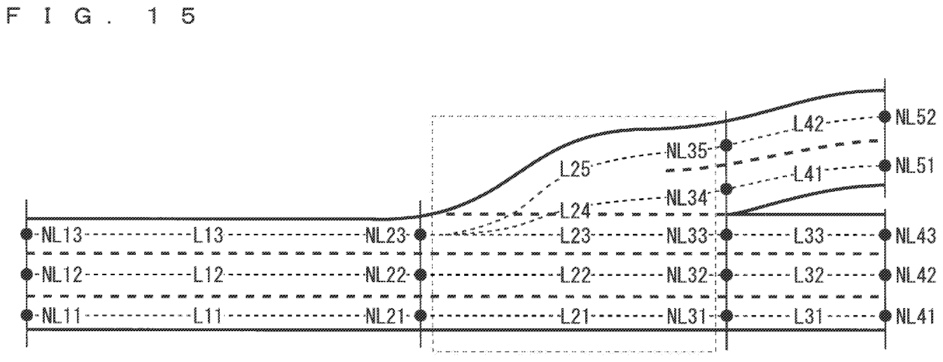

FIG. 14 illustrates a data structure in a case where corresponding information relating to the road link R2 illustrated in FIG. 8 has the representative traffic lane information. In this corresponding information, the traffic lane links L21 to L25 are associated with the road link R2, and in the traffic lane links L21 to L25, the traffic lane links L23 and L25 are described as the representative links and the other traffic lane links L21, L22, and L24 are described as the normal links.

As illustrated in FIGS. 13 and 14, when the first traffic lane reference information or the corresponding information has the representative traffic lane information, the traffic lane reference information acquisition unit 122 extracts the first traffic lane reference information of the representative traffic lane based on the representative traffic lane information (Step S263), and finishes the traffic lane reference information acquisition processing. In the example in FIG. 14, the traffic lane reference information acquisition unit 122 sets the traffic lane links L23 and L25 to the representative traffic lanes, and extracts the first traffic lane reference information of the traffic lane links L23 and L25.

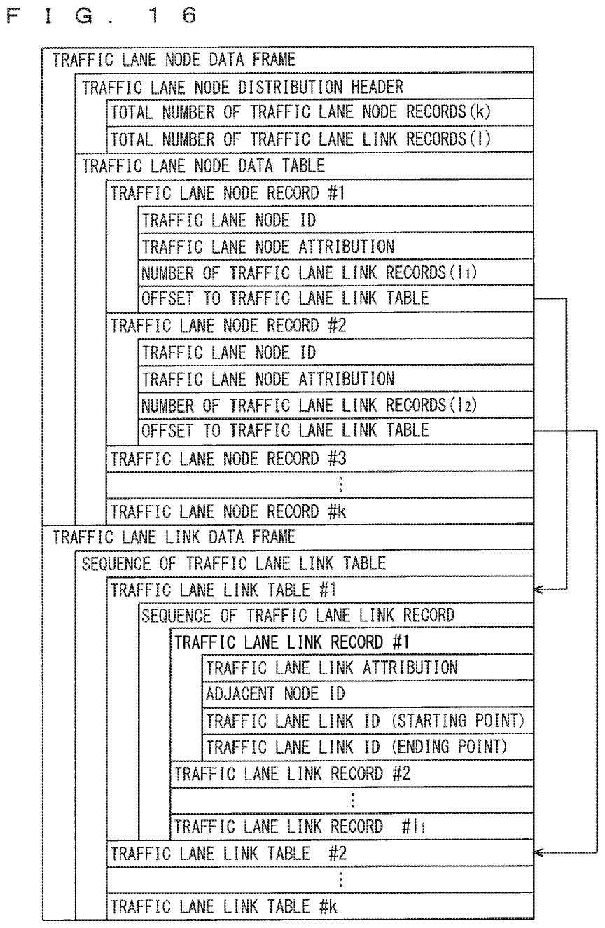

FIG. 15 is a drawing highlighting the representative link illustrated in FIG. 14 by a dotted line in a road expressed by the first traffic lane reference information illustrated in FIG. 8. Since the representative link is the link in units of traffic lanes, the representative link is also referred to as the representative traffic lane. Herein, the traffic lane link L23 is extracted as the representative traffic lane on a main lane side, and the traffic lane link L25 is extracted as the representative traffic lane on a branch lane side. The traffic lane link L25 is the same as the travel traffic lane. As described above, the travel traffic lane is extracted as the representative traffic lane, and in the point having the branch, the representative traffic lane is extracted from the traffic lanes extending in a direction different from that of the travel traffic lane at the branch, thus the guidance information roughly expressing the branch can be created.

When the first traffic lane reference information or the corresponding information does not have the representative traffic lane information in Step S262 in FIG. 12, the traffic lane reference information acquisition unit 122 extracts the first traffic lane reference information of the representative traffic lane based on a predetermined condition (Step S264), and finishes the traffic lane reference information acquisition processing. For example, when the traffic lane links L21 to L25 are described as the traffic lane links corresponding to the road link R2 as is the case in the corresponding information illustrated in FIG. 13, the traffic lane reference information acquisition unit 122 may extract the traffic lane link L21 described in a forefront as the representative traffic lane. Alternatively, the traffic lane reference information acquisition unit 122 may reference a traffic lane link attribution of the first traffic lane reference information and extract the traffic lane located on a leftmost end side or rightmost end side or relating to a branch or junction as the representative traffic lane.

<B-4. Effect>

In the travel assistance device 102 according to the embodiment 2 of the present invention, the traffic lane reference information acquisition unit 122 acquires the first traffic lane reference information of the representative traffic lane which is at least one of the plurality of traffic lanes for each road section in the travel route. The guidance information creation unit 123 creates the guidance information using the first traffic lane reference information of the representative traffic lane in the travel route. According to the travel assistance device 102 described above, the guidance information can be created at high speed using the first traffic lane reference information of the representative traffic lane when the detailed route guidance is not necessary.

When the corresponding information or the first traffic lane reference information includes specific information of the representative traffic lane, the traffic lane reference information acquisition unit 122 can acquire the first traffic lane reference information of the representative traffic lane based on the specific information. In this case, the traffic lane reference information acquisition unit 122 can easily specify the appropriate representative traffic lane.

### C. Embodiment 3

A configuration of the travel assistance device 103 according to the embodiment 3 of the present invention is as illustrated in FIG. 3, and is similar to that of the travel assistance device 102 according to the embodiment 2.

<C-1. Data Structure>

Various types of information used by the travel assistance device 103 for travel assistance processing is described. The information used by the travel assistance device 103 for the travel assistance processing includes three pieces of information, that is, the traffic lane connection information, the first traffic lane reference information, and the corresponding information. These pieces of information are acquired by the information acquisition unit 11, and are offered to the controller 12.

FIG. 16 illustrates a data structure of the traffic lane connection information. The traffic lane connection information is information expressing the road in units of traffic lanes by the plurality of traffic lane nodes and the plurality of traffic lane links. The traffic lane connection information is made by replacing the information of the road node and the road link in the road connection information illustrated in FIG. 4 with the information of the traffic lane node and the traffic lane link. The traffic lane connection information is used for travel route search processing performed by the route search unit 121.

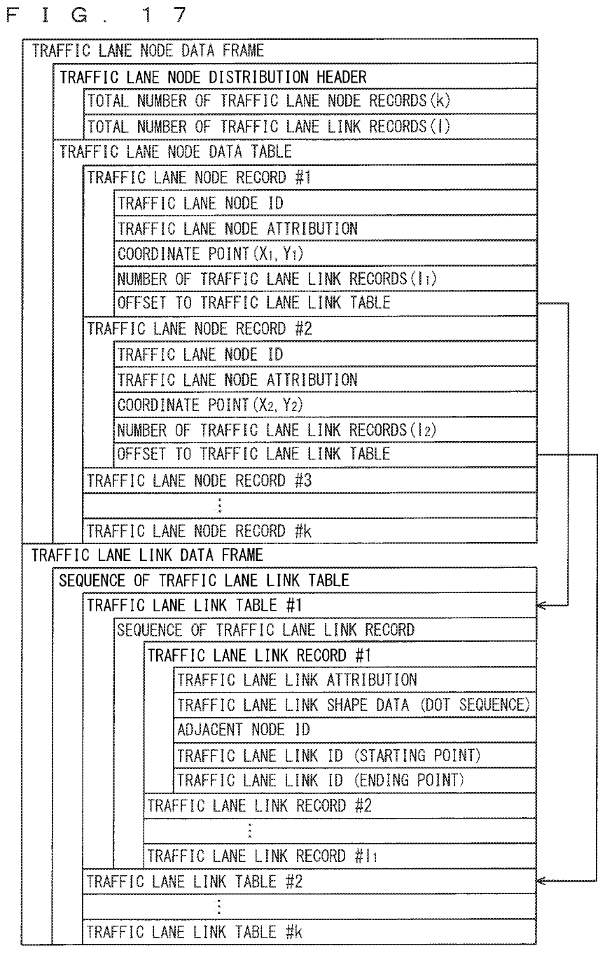

FIG. 17 illustrates the data structure of the first traffic lane reference information and reshows FIG. 5. The first traffic lane reference information is information expressing the road in units of traffic lanes by the plurality of road nodes and the plurality of road links, and is different from the traffic lane connection information in that it includes the shape data of the traffic lane. The first traffic lane reference information is acquired by the traffic lane reference information acquisition unit 122, and is used by the guidance information creation unit 123 for guidance information creation processing.

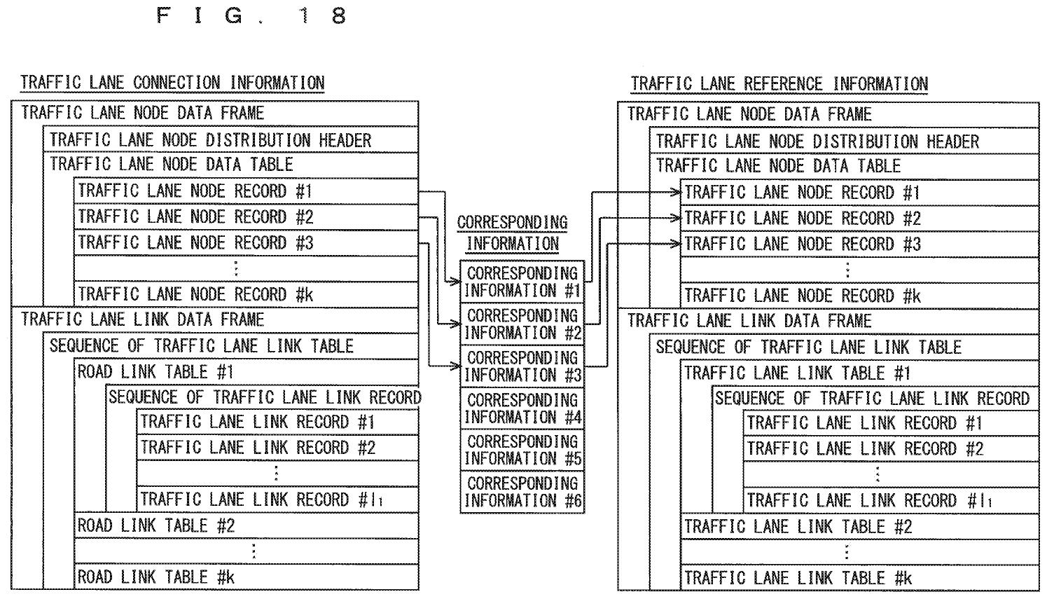

FIG. 18 is a drawing illustrating a relationship between the traffic lane connection information, the first traffic lane reference information, and the corresponding information. As illustrated in FIG. 18, the corresponding information #1 associates the traffic lane node record #1 of the traffic lane connection information with the traffic lane node record #1 of the first traffic lane reference information, the corresponding information #2 associates the traffic lane node record #2 of the traffic lane connection information with the traffic lane node record #2 of the first traffic lane reference information, and the corresponding information #3 associates the traffic lane node record #3 of the traffic lane connection information with the traffic lane node record #3 of the first traffic lane reference information.

In the example in FIG. 18, the traffic lane node record of the traffic lane connection information and the traffic lane node record of the first traffic lane reference information correspond to each other one-on-one. As described above, when the traffic lane connection information and the first traffic lane reference information correspond to each other one-on-one, the corresponding information can be omitted. In that case, the association is ensured by a condition where the traffic lane node IDs or the traffic link IDs are identical with each other or an order of storing the traffic lane node records or the traffic lane link records, that is to say, the number of records.

The corresponding information may be information grouping the plurality of traffic lane links belonging to one road section and collectively associating them with one road link in the manner similar to the embodiment 1.

For example, when the traffic lane connection information and the first traffic lane reference information are established by the other manufacturer, the setting point of the node may be different in the traffic lane connection information and the first traffic lane reference information. In that case, the corresponding information cannot associate the end points of the traffic lane connection information and the first traffic lane reference information, thus may associate the traffic lane link of the traffic lane connection information with both the adjacent two traffic lane links of the first traffic lane reference information or associate the traffic lane link with one of the starting point side and the ending point side of the traffic lane link.

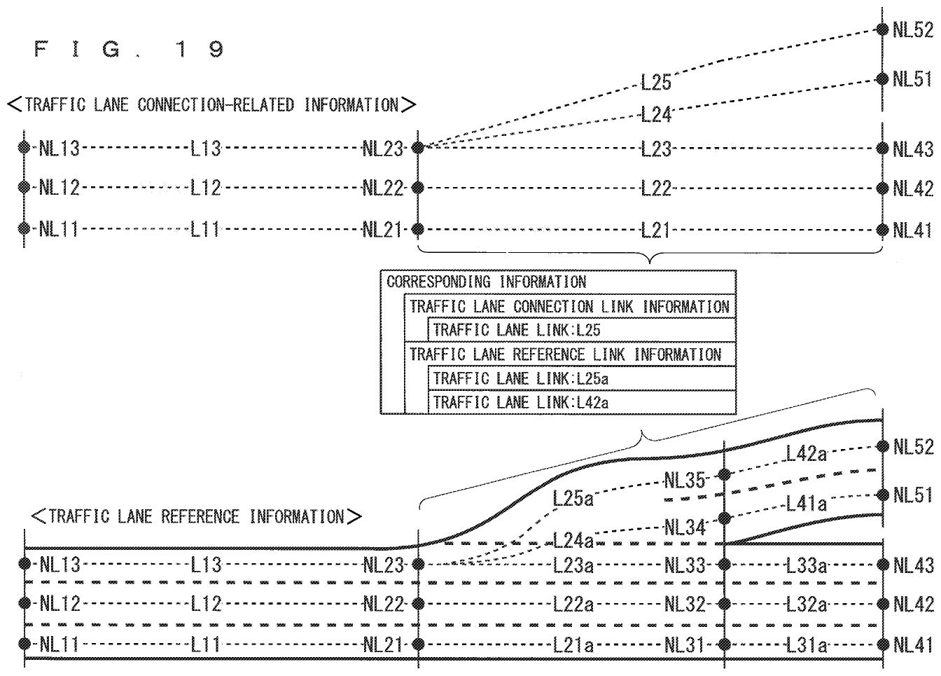

FIG. 19 illustrates corresponding information in a case where a setting point of a node is different between the traffic lane connection information and the first traffic lane reference information. In the corresponding information in FIG. 19, the traffic lane links L25a and L42a of the first traffic lane reference information are associated with the traffic lane link L25 of the traffic lane connection information. In the corresponding information in FIG. 19, in order to distinguish the traffic lane link information in the traffic lane connection information from the traffic lane link information in the first traffic lane reference information, the former is described as the traffic lane connection link information and the latter is described as the traffic lane reference link information.

<C-2. Operation>

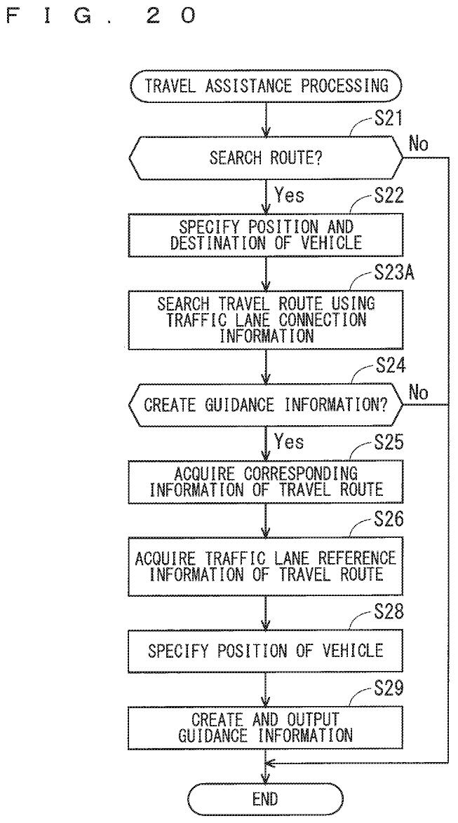

FIG. 20 is a flow chart illustrating travel assistance processing performed by the travel assistance device 103. The flow in FIG. 20 is similar to the flow in FIG. 9 except that Step S23 is replaced with Step S23A and Step S27 is deleted in the flow of the travel assistance device 102 illustrated in FIG. 9. In Step S23A, the route search unit 121 searches the travel route in units of traffic lanes using the traffic lane connection information. Since the traffic lane connection information is the road information in units of traffic lanes, a travel cost such as a fuel cost or a distance can be calculated in more detail compared to the embodiment 1 by performing the travel route search using the traffic lane connection information. The traffic lane connection information does not include the shape data of the traffic lane, differing from the first traffic lane reference information. Accordingly, the route search unit 121 searches the travel route using the traffic lane connection information, thereby being able to perform the route search at high speed with less calculation load compared to a case of using the first traffic lane reference information.

<C-3. Travel Route Search Processing>

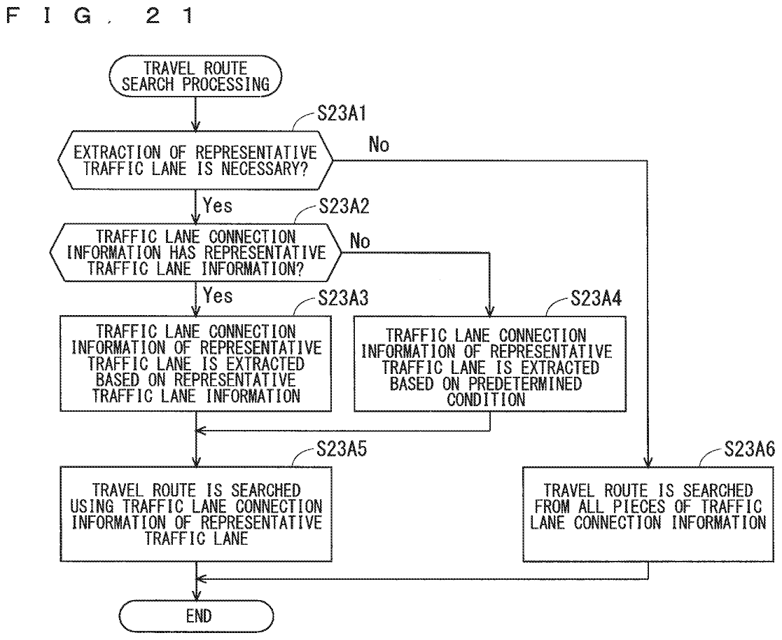

FIG. 21 is a flow chart illustrating details of the travel route search processing performed by the route search unit 121 (Step S23A). Firstly, the route search unit 121 determines whether or not the extraction of the representative traffic lane is necessary (Step S23A1). A case where the extraction of the representative traffic lane is necessary means a case where it is sufficient to search the travel route using only the traffic lane connection information of the representative traffic lane. For example, it is considered to be necessary to accurately search the travel route in units of traffic lanes in a case where a calculation section of the travel route is located near the vehicle, however, it is considered to be sufficient to search the travel route for only the representative traffic lane in a case where the calculation section of the travel route is located far away from the vehicle. Accordingly, the route search unit 121 can perform the determination of Step S23A1 based on a distance from the calculation section of the travel route to the position of the vehicle, for example.

When the route search unit 121 determines that the extraction of the representative traffic lane is unnecessary, the route search unit 121 searches the travel route from the traffic lane connection information of all of the traffic lanes (Step S23A6), and finishes the travel route search processing. In the meanwhile, when the route search unit 121 determines that the extraction of the representative traffic lane is necessary, the route search unit 121 determines whether or not the traffic lane connection information has the representative traffic lane information (Step S23A2).

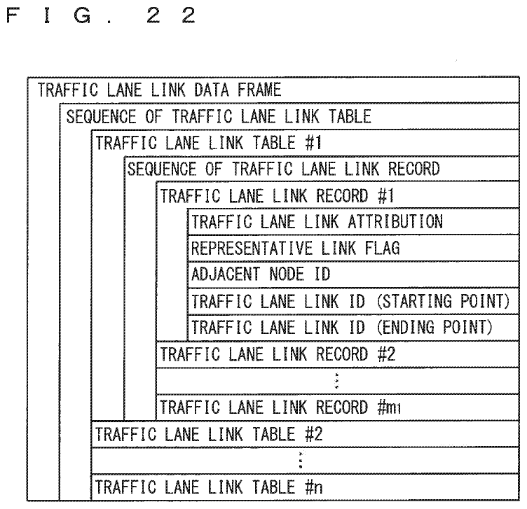

FIG. 22 illustrates a data structure of the traffic lane connection information having the representative traffic lane information. The traffic lane connection information in FIG. 22 has a representative link flag in a traffic lane link record. In the traffic lane link record of the representative traffic lane, the representative link flag indicates 1, and in the traffic lane link record of the traffic lane other than the representative traffic lane, the representative link flag indicates 0. As described above, the representative link flag is the representative traffic lane information.

When the traffic lane connection information has the representative traffic lane information as illustrated in FIG. 22, the route search unit 121 extracts the traffic lane connection information of the representative traffic lane based on the representative traffic lane information (Step S23A3). That is to say, in the example in FIG. 22, the route search unit 121 acquires the traffic lane link record having the representative link flag of 1 and the traffic lane node record to which the traffic lane link record is connected.

In the meanwhile, when the traffic lane connection information does not have the representative traffic lane information, the route search unit 121 extracts the traffic lane connection information of the representative traffic lane based on a predetermined condition (Step S23A4). Herein, the route search unit 121 can set, to the representative traffic lane, the traffic lane link stored in a forefront in the traffic lane connection information in the traffic lane link of the road section including the representative traffic lane which is intended to be extracted. Alternatively, the traffic lane reference information acquisition unit 122 may reference a traffic lane link attribution of the traffic lane connection information and set the traffic lane located on a leftmost end side or rightmost end side or relating to a branch or junction to the representative traffic lane.

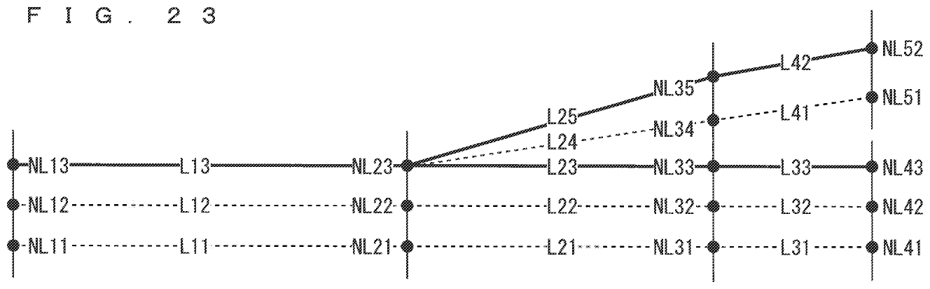

FIG. 23 is a drawing illustrating a road expressed by the traffic lane connection information and a representative traffic lane in the road. In FIG. 23, a normal traffic lane is indicated by a dotted line and the representative traffic lane is indicated by a solid line. A branch occurs in a traffic lane node NL23, thus the traffic lane link L23 is selected as the traffic lane link of the representative traffic lane from among the traffic lane links L21 to L23 in a main lane side, and the traffic lane link L25 is selected as the traffic lane link of the representative traffic lane from among the traffic lane links L24 and L25 in a branch lane side. As described above, when there is the branch, at least one representative traffic lane is selected in each of the main lane side and the branch lane side, thus the travel cost on each side can be calculated and the travel route search can be appropriately performed. The information whether the traffic lane link is located in the main lane side or the branch lane side can be recognized from the traffic lane link attribution of the traffic lane connection information, for example.

Returning to FIG. 21, after Step S23A3 or Step S23A4, the route search unit 121 searches the travel route using the traffic lane connection information of the extracted representative traffic lane (Step S23A5), and finishes the travel route search processing.

As described above, the route search unit 121 sets at least one traffic lane in the plurality of traffic lanes to the representative traffic lane (the first representative traffic lane) for each road section as necessary, and searches the travel route using the traffic lane connection information of the first representative traffic lane, thereby being able to perform the efficient route search with less calculation load.

When the traffic lane connection information includes specific information of the first representative traffic lane, the route search unit 121 can set the first representative traffic lane in accordance with the specific information, thus can set the first representative traffic lane with less calculation amount.

<C-4. Traffic Lane Reference Information Acquisition Processing>

Next, the traffic lane reference information acquisition processing performed by the traffic lane reference information acquisition unit 122 (Step S26 in FIG. 20) is described. The traffic lane reference information acquisition unit 122 acquires the first traffic lane reference information of the necessary traffic lane from among the traffic lanes in the same road section as the travel route searched in units of traffic lanes in Step S23A.

The flow of the traffic lane reference information acquisition processing performed by the traffic lane reference information acquisition unit 122 of the travel assistance device 103 is similar to the flow in the embodiment 2 illustrated in FIG. 12. That is to say, the traffic lane reference information acquisition unit 122 extracts the first traffic lane reference information of the representative traffic lane from among the traffic lanes in the same road section as the travel route when the representative traffic lane needs to be extracted, and acquires the first traffic lane reference information of all of the traffic lanes in the same road section as the travel route when the representative traffic lane needs not be extracted.

Herein, the representative traffic lane set by the route search unit 121 is referred to as a first representative traffic lane and the representative traffic lane extracted by the traffic lane reference information acquisition unit 122 is referred to as a second representative traffic lane so that they are distinguished from each other. The first representative traffic lane is the representative traffic lane defined from a viewpoint of the route search, and the second representative traffic lane is the representative traffic lane defined from a viewpoint of creating the guidance information. Accordingly, the first representative traffic lane and the second representative traffic lane may be the same as or different from each other. For example, in the example in FIG. 23, the route search unit 121 selects, as the traffic lane link of the first representative traffic lane, the traffic lane links L23 and L25 from among the traffic lane links L23 to L25 connected to the traffic lane node NL23 to focus on a connection of the routes. In the meanwhile, the traffic lane reference information acquisition unit 122 can select the traffic lane link L21 or L22 in place of the traffic lane link L23 as the second representative traffic lane to extract the representative traffic lane necessary to create the guidance information.

When a map scale of a guidance information screen is large even in a case where the route search unit 121 searches the travel route in detail using the traffic lane connection information of all of the traffic lanes, the guidance information of low accuracy may suffice as the guidance information screen, and the first traffic lane reference information of all of the traffic lanes may be unnecessary to create the guidance information in some cases. Accordingly, the traffic lane reference information acquisition unit 122 can select the second representative traffic lane even in the case where the route search unit 121 does not select the first representative traffic lane.

The representative traffic lane information for the traffic lane reference information acquisition unit 122 extracting the second representative traffic lane needs to be described in any of the first traffic lane reference information or the corresponding information. The data structure of the first traffic lane reference information in which the representative traffic lane information is described is similar to the data structure illustrated in FIG. 13, for example, and the representative link flag may be stored in the traffic lane link record.

FIG. 24 illustrates the data structure of the corresponding information in which the representative traffic lane information is described. The corresponding information illustrated in FIG. 24 indicates a correspondence relationship between the traffic lane link of the traffic lane link information in the traffic lane connection information (indicated as “traffic lane connection link information” in FIG. 24) and the traffic lane link of the traffic lane link information in the first traffic lane reference information (indicated as “traffic lane reference link information” in FIG. 24). The traffic lane links L21 to L25 of the first traffic lane reference information are associated with the traffic lane links L21 to L25 of the traffic lane connection information, and therein, the traffic lane links L23 and L25 of the first traffic lane reference information are set to the traffic lane links of the representative traffic lane (indicated as “representative link” in FIG. 24), and the traffic lane links L21, L22, and L24 are set to the traffic lane links of the traffic lane other than the representative traffic lane (indicated as “normal link” in FIG. 24).

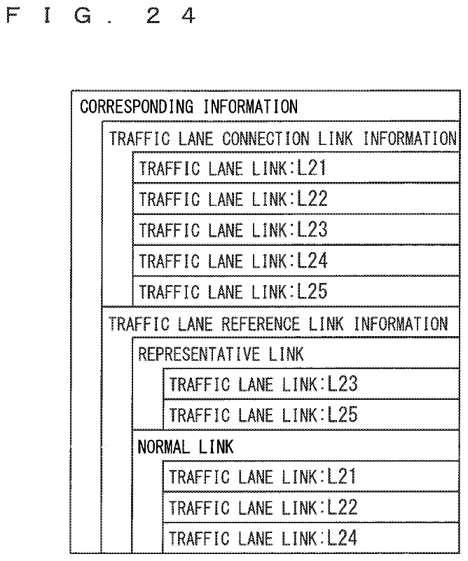

FIG. 25 is a drawing illustrating a road expressed by the first traffic lane reference information and a representative traffic lane in the road. In FIG. 25, the normal traffic lane is indicated by a dotted line and the representative traffic lane is indicated by a solid line. A branch occurs in the traffic lane node NL23, thus the traffic lane link L21 is selected as the traffic lane link of the representative traffic lane from among the traffic lane links L21 to L23 in the main lane side, and the traffic lane link L25 is selected as the traffic lane link of the representative traffic lane from among the traffic lane links L24 and L25 in the branch lane side. As described above, when there is the branch, at least one representative traffic lane is selected in each of the main lane side and the branch lane side, thus the appropriate guidance information at the branch can be created. The information whether the traffic lane link is located in the main lane side or the branch lane side can be recognized from the traffic lane link attribution of the first traffic lane reference information, for example.

As described above, according to the travel assistance device 103 according to the embodiment 3, the traffic lane reference information acquisition unit 122 extracts at least one traffic lane in the plurality of traffic lanes as the second representative traffic lane for each road section of the travel route, and acquires the first traffic lane reference information of the second representative traffic lane. According to the travel assistance device 103 described above, the guidance information can be created at high speed using the first traffic lane reference information of the representative traffic lane when the detailed route guidance is not necessary.

When the first traffic lane reference information includes specific information of the second representative traffic lane, the traffic lane reference information acquisition unit 122 can extract the second representative traffic lane based on the specific information included in the first traffic lane reference information. In this case, the traffic lane reference information acquisition unit 122 can easily specify the appropriate representative traffic lane.

When the information acquisition unit 11 acquires the corresponding information associating the road connection information with the first traffic lane reference information and including the specific information of the second representative traffic lane, the traffic lane reference information acquisition unit 122 can extract the second representative traffic lane based on the specific information included in the corresponding information. In this case, the traffic lane reference information acquisition unit 122 can easily specify the appropriate representative traffic lane.

<C-5. Effect>

As described above, the travel assistance device 103 according to the embodiment 3 includes: an information acquisition unit 11 acquiring traffic lane connection information which expresses a connection relationship of roads in units of traffic lanes and does not include shape information of traffic lanes and first traffic lane reference information which expresses a connection relationship of roads in units of traffic lanes and includes shape information of the traffic lanes; a route search unit 121 searching a travel route of the vehicle using the traffic lane connection information; a traffic lane reference information acquisition unit 122 acquiring the first traffic lane reference information of the traffic lane necessary to perform a leading guidance of the travel route; and a guidance information creation unit 123 creating guidance information for guiding the vehicle using the first traffic lane reference information acquired by the traffic lane reference information acquisition unit 122. According to the travel assistance device 103 described above, the traffic lane connection information does not include the shape information of the traffic lane, thus a reading data amount is reduced in the route search, and the route search can be efficiently performed at high speed. Since the traffic lane connection information is road information in units of traffic lanes, the travel assistance device 103 can search the travel route in more detail compared to the case of using the road connection information. The travel assistance device 103 can create the detailed guidance information by the first traffic lane reference information including the shape information of the traffic lane.

### D. Embodiment 4

In the embodiment 3, the traffic lane connection information is used in a screen of the route search, and the traffic lane reference information is used in a screen of creating the guidance information, thus the different pieces of information are used in the both screens. In this case, the traffic lane connection information and the traffic lane reference information may be established by different manufacturer, and this case has an advantage that the both pieces of information can be updated separately as long as the both pieces of information are associated with each other by the corresponding information. However, the traffic lane reference information is the same data as the traffic lane connection information except that it has the shape data of the traffic lane link, thus has a problem that the handling of such two duplicated data is redundant.

Thus, in the embodiment 4, the road information in the same units of traffic lanes is used in the screens of the route search and creating the guidance information.

<D-1. Configuration>

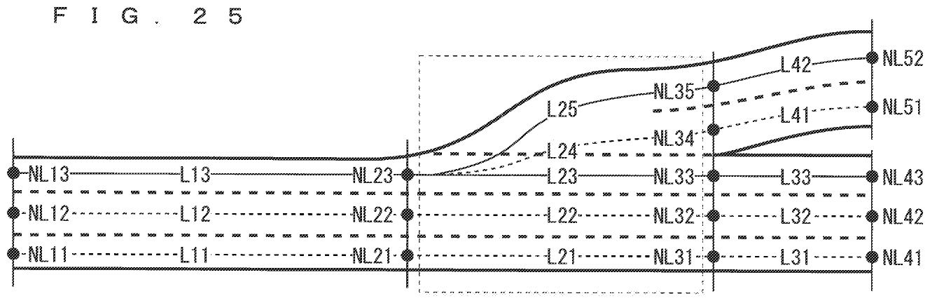

FIG. 26 is a block diagram illustrating a configuration of a travel assistance device 104 according to an embodiment 4 of the present invention. The travel assistance device 104 includes a shape information acquisition unit 124 in place of the traffic lane reference information acquisition unit 122 of the travel assistance devices 102 and 103 according to the embodiments 2 and 3, and the other configuration is similar to the configuration of the travel assistance devices 102 and 103.

<D-2. Data Structure>

The travel assistance device 104 uses second traffic lane reference information for travel assistance processing. These second traffic lane reference information is acquired by the information acquisition unit 11, and are offered to the controller 12.

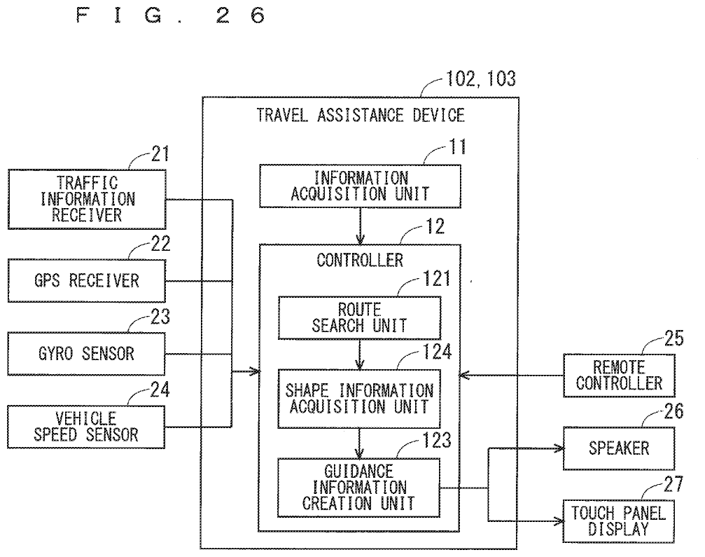

FIG. 27 illustrates a data structure of the second traffic lane reference information. The second traffic lane reference information is information expressing the road in units of traffic lanes by the plurality of traffic lane nodes and the plurality of traffic lane links. When the second traffic lane reference information illustrated in FIG. 27 and the first traffic lane reference information illustrated in FIG. 17, for example, are compared to each other, they are different from each other in that in the second traffic lane reference information, the traffic lane link shape data is not stored in the traffic lane link record but stored in the traffic lane link shape data frame different from the traffic lane link data frame. As described above, the second traffic lane reference information has the connection information indicating the connection relationship of the roads in units of traffic lanes in the traffic lane node data frame and the traffic lane link data frame, and has the shape information indicating the shape of the traffic lane in the traffic lane link shape data frame.

The second traffic lane reference information has a traffic lane link shape data offset in the traffic lane link record. The traffic lane link shape data offset stores an offset value to an address in which the traffic lane link shape data frame is stored.

<D-3. Operation>

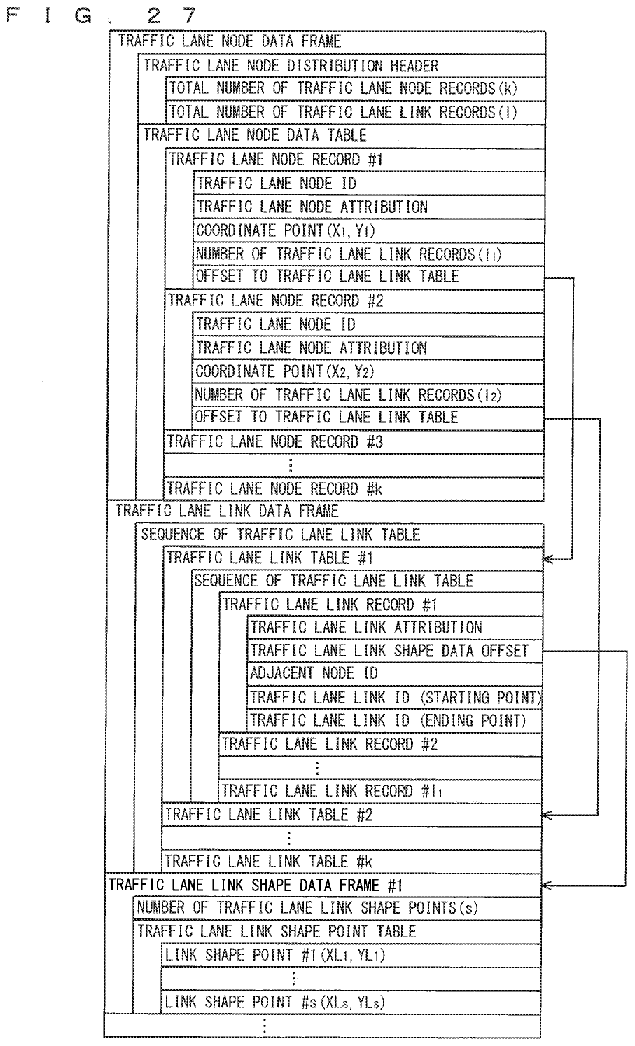

FIG. 28 is a flow chart illustrating travel assistance processing performed by the travel assistance device 104. The flow in FIG. 28 is similar to the flow in FIG. 9 except that Step S23 and Step S26 are replaced with Step S23B and Step S26B, and Steps S25 and S27 are deleted in the flow of the travel assistance device 102 illustrated in FIG. 9. Accordingly, the flow of FIG. 28 is described centering on a difference with the flow of FIG. 9.

When the travel assistance device 104 specifies the position and destination of the vehicle in Step S22 in FIG. 28, the travel assistance device 104 searches the travel route using the connection information in the second traffic lane reference information, that is to say, the traffic lane node data and the traffic lane link data (Step S23B). This processing is similar to the processing performed by the route search unit 121 searching the travel route using the traffic lane connection information in the embodiment 3. Herein, the travel route search unit may perform efficiently the travel route search using only the traffic lane node data and the traffic lane link data of the representative traffic lane or may perform the travel route search in detail using the traffic lane node data and the traffic lane link data of all of the traffic lanes. The method of setting the representative traffic lane (the first representative traffic lane) performed by the route search unit 121 is similar to that in the embodiment 3. That is to say, the route search unit 121 may determine whether or not the traffic lane is the representative traffic lane with reference to the representative link flag (not shown in FIG. 27) of the traffic lane link record, or may set the representative traffic lane under a predetermined condition when the traffic lane link records does not have the such specification information of the representative traffic lane. The route search unit 121 may reference a traffic lane link attribution and set the traffic lane located on a leftmost end side or rightmost end side or relating to a branch or junction to the representative traffic lane, for example.

Next, upon determination that the guidance information is created (Step S24), the shape information acquisition unit 124 acquires the traffic lane link shape data regarding the travel route searched in Step S23B (Step S26B). The shape information acquisition unit 124 references “the traffic lane link shape data offset” in the traffic lane link record, thereby being able to acquire the traffic lane link shape data of the desired traffic lane link. Herein, “the traffic lane link shape data regarding the travel route” means the traffic lane link shape data of the traffic lane necessary to create the guidance information of the travel route. The traffic lane necessary to create the guidance information of the travel route includes the traffic lane of the travel route searched in Step S23B and the representative traffic lane other than the traffic lane of the travel route searched in Step S23B, for example.

<D-4. Effect>

As described above, the travel assistance device 104 according to the embodiment 4 includes: an information acquisition unit 11 acquiring second traffic lane reference information having each of connection information indicating a connection relationship of roads in units of traffic lanes and shape information indicating a shape of a traffic lane in a different data frame; a route search unit 121 searching a travel route of the vehicle using the connection information of the second traffic lane reference information; a shape information acquisition unit 124 acquiring shape information of the travel route from the second traffic lane reference information; and a guidance information creation unit 123 creating guidance information for guiding the vehicle to the travel route using the connection information and the shape information of the travel route. According to the travel assistance device 104 having such a configuration, the route search and the creation of the guidance information are performed using one traffic lane connection information, thus the data amount to be handled can be reduced.

The route search unit 121 sets at least one traffic lane in the plurality of traffic lanes to the representative traffic lane for each road section, and searches the travel route using the connection information of the representative traffic lane, thereby being able to perform the route search efficiently.

When the second traffic lane reference information includes the specific information of the representative traffic lane, the route search unit 121 can set the representative traffic lane in accordance with the specific information of the second traffic lane reference information. In this case, the route search unit 121 can easily specify the appropriate representative traffic lane.

### E. Hardware Configuration

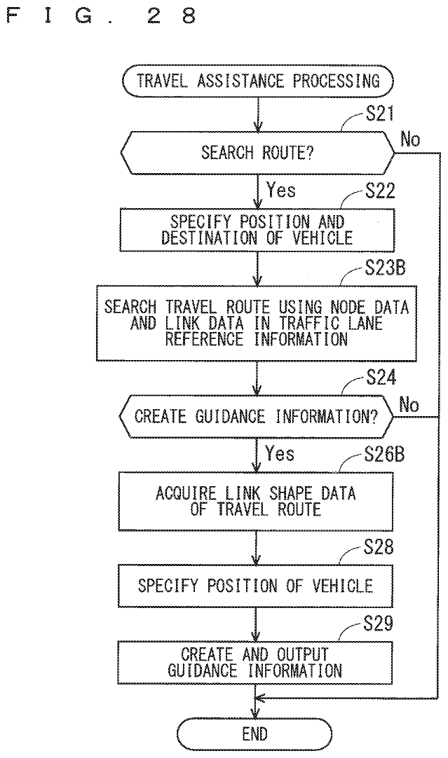

The information acquisition unit 11 and the controller 12 in the travel assistance devices 101 to 104 described above are achieved by a processing circuit 51 illustrated in FIG. 29. That is to say, the processing circuit 51 includes the information acquisition unit 11, the route search unit 121, the traffic lane reference information acquisition unit 122, the guidance information creation unit 123, and the shape information acquisition unit 124 (referred to as “the route search unit 121 etc.” hereinafter). Dedicated hardware may be applied to the processing circuit 51, or a processor executing a program stored in a memory may also be applied. Examples of the processor include a central processing unit, a processing device, an arithmetic device, a microprocessor, a microcomputer, or a digital signal processor (DSP).

When the processing circuit 51 is the dedicated hardware, a single circuit, a complex circuit, a programmed processor, a parallel-programmed processor, an application specific integrated circuit (ASIC), a field-programmable gate array (FPGA), or a combination of them, for example, falls under the processing circuit 51. Each function of the route search unit 121 etc. may be achieved by the plurality of processing circuits 51, or each function of them may also be collectively achieved by one processing circuit.

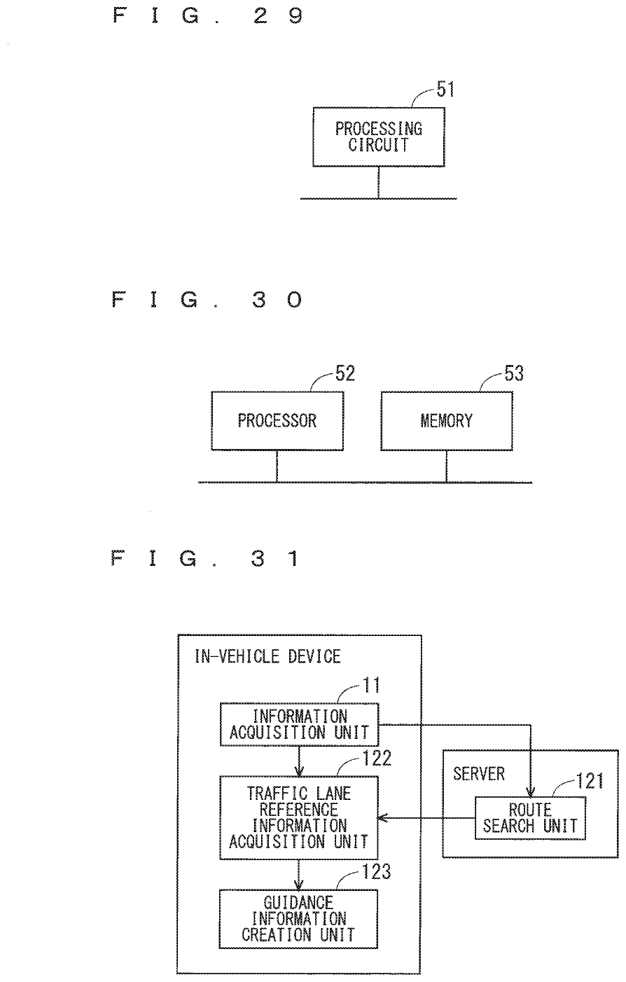

When the processing circuit 51 is the processor, the functions of the route search unit 121 etc. are achieved by a combination with software (software, firmware, or software and firmware), for example. The software, for example, is described as a program and is stored in a memory. As illustrated in FIG. 30, a processor 52 applied to the processing circuit 51 reads out and executes a program stored in a memory 53, thereby achieving the function of each unit. That is to say, the travel assistance devices 101 to 104 include the memory 53 to store the program to resultingly execute, at a time of being executed by the processing circuit 51, steps of: acquiring road connection information which expresses a connection relationship of roads in units of roads and does not include shape information of roads, traffic lane reference information which expresses a connection relationship of roads in units of traffic lanes and includes shape information of the traffic lanes, and corresponding information which associates the road connection information with traffic lane reference information; searching a travel route of a vehicle using the road connection information; acquiring the traffic lane reference information of the travel route from the road connection information and the corresponding information of the travel route; and creating guidance information for guiding the vehicle using the traffic lane reference information of the travel route. In other words, this program is also deemed to make a computer execute a procedure or a method of the route search unit 121 etc. Herein, the memory 53 may be a non-volatile or volatile semiconductor memory such as a RAM (Random Access Memory), a ROM (Read Only Memory), a flash memory, an EPROM (Electrically Programmable Read Only Memory), or an EEPROM (Electrically Erasable Programmable Read Only Memory), an HDD (Hard Disk Drive), a magnetic disc, a flexible disc, an optical disc, a compact disc, a mini disc, a DVD (Digital Versatile Disc), or a drive device of them, or any storage medium which is to be used in the future.

Described above is the configuration that each function of the route search unit 121 etc. is achieved by one of the hardware and the software, for example. However, the configuration is not limited thereto, but also applicable is a configuration of achieving a part of the route search unit 121 etc. by dedicated hardware and achieving another part of them by software, for example. For example, the function of the route search unit 121 can be achieved by a processing circuit as the dedicated hardware, and the function of the other units can be achieved by the processing circuit 51 as the processor 52 reading out and executing the program stored in the memory 53.

As described above, the processing circuit can achieve each function described above by the hardware, the software, or the combination of them, for example.

The travel assistance devices 101 to 104 are described as in-vehicle devices in the above description, however, the travel assistance devices 101 to 104 can also be applied to an in-vehicle device, a Portable Navigation Device (PND), a communication terminal (a portable terminal such as a mobile phone, a smartphone, or a tablet, for example), a function of an application installed on them, and a navigation system constructed as a system by appropriately combining a server, for example. In this case, each function or each constituent element of the travel assistance devices 101 to 104 described above may be dispersedly disposed in each apparatus constructing the system, or may also be collectively disposed in one of the apparatuses. As one example thereof, FIG. 31 illustrates a block diagram in a case where the travel assistance devices 101 to 103 are made up of an in-vehicle device and a server. In this example, the in-vehicle device includes the information acquisition unit 11, the traffic lane reference information acquisition unit 122, and the guidance information creation unit 123, and the server includes the route search unit 121. In such a configuration, the server performs the route search, thus the calculation load of the in-vehicle device is reduced.

According to the present invention, each embodiment can be arbitrarily combined, or each embodiment can be appropriately varied or omitted within the scope of the invention.

The present invention has been shown and described in detail, the foregoing description is in all aspects illustrative and not restrictive. It is therefore understood that numerous modifications and variations can be devised without departing from the scope of the invention.

### EXPLANATION OF REFERENCE SIGNS

11 information acquisition unit, 12 controller, 21 traffic information receiver, 22 GPS receiver, 23 gyro sensor, 24 vehicle speed sensor, 25 remote controller, 26 speaker, 27 touch panel display, 31 road object, 32 vehicle icon, 33 travel route, 34 direction icon, 35 map scale, 36 representative traffic lane, 51 processing circuit, 52 processor, 53 memory, 101 to 104 travel assistance device, 121 route search unit, 122 traffic lane reference information acquisition unit, 123 guidance information creation unit, 124 shape information acquisition unit

1. A travel assistance device, comprising:
a processor to execute a program; and
a memory to store the program which, when executed by the processor, performs processes of,
acquiring road connection information which expresses a connection relationship of roads in units of roads by a plurality of road nodes and a plurality of road links connecting each of the plurality of road nodes and does not include a coordinate of a road link shape point constituting each of the plurality of road links, first traffic lane reference information which expresses a connection relationship of roads in units of traffic lanes by a plurality of traffic lane nodes and a plurality of traffic lane links connecting each of the plurality of traffic lane nodes and includes a coordinate of a traffic lane link shape point constituting each of the plurality of traffic lane links, and corresponding information which associates the road connection information with first traffic lane reference information;
searching a travel route of a vehicle using the road connection information;
acquiring the first traffic lane reference information of a traffic lane necessary to perform a leading guidance of the travel route from the road connection information and the corresponding information of the travel route; and
creating guidance information for guiding the vehicle using the first traffic lane reference information of the travel route.

2. The travel assistance device according to claim 1, wherein
in the acquisition of the first traffic lane reference information, the first traffic lane reference information of a representative traffic lane, which is at least one traffic lane in a plurality of traffic lanes, is acquired for each road section of the travel route, and
the guidance information is created using the first traffic lane reference information of the representative traffic lane of the travel route.

3. The travel assistance device according to claim 2, wherein
the corresponding information or the first traffic lane reference information includes specific information of the representative traffic lane, and
in the acquisition of the first traffic lane reference information, the first traffic lane reference information of the representative traffic lane is acquired based on the specific information included in the corresponding information or the first traffic lane reference information.

4. A travel assistance device, comprising:
a processor to execute a program; and
a memory to store the program which, when executed by the processor, performs processes of,
acquiring traffic lane connection information which expresses a connection relationship of roads in units of traffic lanes by a plurality of traffic lane nodes and a plurality of traffic lane links connecting each of the plurality of traffic lane nodes and does not include a coordinate of a traffic lane link shape point constituting each of the plurality of traffic lane links and first traffic lane reference information which expresses a connection relationship of roads in units of traffic lanes by the plurality of traffic lane nodes and the plurality of traffic lane links and includes a coordinate of a traffic lane link shape point constituting each of the plurality of traffic lane links,
searching a travel route of a vehicle using the traffic lane connection information;
acquiring the first traffic lane reference information of a traffic lane necessary to perform a leading guidance of the travel route based on the traffic lane connection information of the travel route; and
creating guidance information for guiding the vehicle using the acquired first traffic lane reference information.

5. The travel assistance device according to claim 4, wherein
in the searching, at least one traffic lane in a plurality of traffic lanes is set to a first representative traffic lane for each road section, and the travel route is searched using the traffic connection information of the first representative traffic lane.

6. The travel assistance device according to claim 5, wherein
the traffic lane connection information includes specific information of the first representative traffic lane, and
the first representative traffic lane is set according to the specific information of the traffic lane connection information.

7. The travel assistance device according to claim 4, wherein
in the acquisition of the first traffic lane reference information, at least one traffic lane in a plurality of traffic lanes is extracted as a second representative traffic lane for each road section of the travel route, and the first traffic lane reference information of the second representative traffic lane is acquired.

8. The travel assistance device according to claim 7, wherein
the first traffic lane reference information includes specific information of the second representative traffic lane, and
the second representative traffic lane is extracted based on the specific information included in the first traffic lane reference information.

9. The travel assistance device according to claim 7, wherein
the travel assistance device associates the traffic lane connection information with the first traffic lane reference information, and acquires corresponding information including specific information of the second representative traffic lane, and
the second representative traffic lane is extracted based on the specific information included in the corresponding information.

10. A travel assistance device, comprising:
acquiring second traffic lane reference information which has each of connection information indicating a connection relationship of roads in units of traffic lanes by a plurality of traffic lane nodes and a plurality of traffic lane links connecting each of the plurality of traffic lane nodes and shape information including a coordinate of a traffic lane link shape point constituting each of the plurality of traffic lane links and indicating a shape of traffic lanes in a different data frame;
searching a travel route of a vehicle using the connection information of the second traffic lane reference information;
acquiring the shape information of the travel route from the second traffic lane reference information; and
creating guidance information for guiding the vehicle to the travel route using the connection information and the shape information of the travel route.

11. The travel assistance device according to claim 10, wherein
in the searching, at least one traffic lane in a plurality of traffic lanes is set to a representative traffic lane for each road section, and the travel route is searched using the connection information of the representative traffic lane.

12. The travel assistance device according to claim 11, wherein
the second traffic lane reference information includes specific information of the representative traffic lane, and
the representative traffic lane is set according to the specific information of the second traffic lane reference information.

13-14. (canceled)
